(19) United States
(12) Patent Application Publication
(10) Pub. No.: US 2008/0026129 A1
(43) Pub. Date: Jan. 31, 2008

(54) System for real-time characterization of ruminant feed components

(76) Inventor: James F. Beck, Rogers, MN (US)

Correspondence Address: Moss & Barnett P.A., 4800 Wells Fargo Center, 90 South Seventh Street, Minneapolis, MN, 55402-4129, US

(21) Appl. No.: 11/881,481

(22) Filed: Jul. 27, 2007

Related U.S. Application Data
(63) Continuation-in-part of application No. 11/494,312, filed on Jul. 27, 2006.

(51) Int. Cl. A23K 1/00

(52) U.S. Cl. 426/623

(57) ABSTRACT

A computer-based system for characterizing in real time the nutritional components of one of more ingredients for a ruminant feed ration, including dry matter, NDF, NDFd, lignified NDF ratio, percent starch, IVSD, and particle size for a forage material; and IVSD and particle size for a grain material. The system utilizes proprietary NIRS equations based upon prior samplings of a variety of crop species like dual-purpose corn silage, leafy corn silage, brown midrib (“BMR”) corn silage, grass (silage/dry), alfalfa (silage/dry), BMR forage sorghum, normal dent starch grain, floury endosperm starch grain, and vitreous endosperm grain, and applies those equations to current samplings of a corresponding crop to predict in real time the characteristics of such forage or grain material. The real-time characterization system may also utilize the predicted data to calculate a “ration fermentability index” value that takes into account the total NDFd and IVSD characteristics (including RAS and RBS) of the forage and starch ingredients to be used in a feed ration to ensure that the ration will not contribute too much or too little digestibility to the cow.

### CROSS-REFERENCE TO RELATED APPLICATION

This application is a continuation-in-part of U.S. Ser. No. 11/494,312 filed on Jul. 27, 2006, which is hereby incorporated by reference in its entirety.

### FIELD OF THE INVENTION

The present invention relates to a system for screening a crop plant for the plant's starch and/or fiber digestion characteristics. Particularly, the present invention is a system for accurately predicting the starch and fiber digestion characteristics of a crop plant by Near Infrared Spectrometer (“NIRS”) analysis and preserving the identity of the crop plants in order to create feed formulations that result in optimum productivity of ruminant animals.

### BACKGROUND OF THE INVENTION

Starch is a major component of ruminant diets, often comprising over 30% of lactating dairy cow diets and over 60% of diets for beef feedlot finishing diets on a dry matter (“DM”) basis. In ruminants, starch can be fermented to volatile fatty acids in the rumen, digested to glucose in the small intestine, or fermented to volatile fatty acids in the large intestine. Degradability of dietary starch affects site of digestion and whole tract digestibility. Site of digestion, in turn, affects fermentation acid production, ruminal pH, microbial yield, and efficiency of microbial protein production. All such factors can affect the productivity of ruminant animals. Many factors affect site of starch digestion in ruminants including DM intake, forage content of the diet, processing, and conservation methods. Grain processing is costly but is often justified economically to increase degradability of starch. High moisture corn grain generally has higher starch degradability than dry corn grain. This is partly because vitreousness of corn endosperm increases with maturity at harvest (Philippeau and Michalet-Doreau, 1997). In addition, ensiling corn increases starch degradability (Philippeau and Michalet-Doreau, 1999). Stock et al. (1991) reported that solubility of endosperm proteins was highly related to moisture level in high moisture corn and solubility increased with time of storage. Endosperm proteins seem to decrease access of starch granules to amylolytic enzymes.

Endosperm type also affects starch degradability, and it is well known that the proportion of vitreous and floury endosperm varies by corn hybrid. Dado and Briggs (1996) reported that in vitro starch digestibility (“IVSD”) of seven hybrids of corn with floury endosperm was much higher than that for one yellow dent hybrid. Philippeau et al., (1996) reported much higher in situ ruminal starch degradation for dent corn compared to flint corn harvested at both the hard dough stage and mature (300 g kg⁻1 and 450 g kg⁻1 whole plant DM, respectively). Grain (grain refers broadly to a harvested commodity) processing increases the availability of starch in floury endosperm much more than starch in vitreous endosperm (Huntington, 1997). Cells in the floury endosperm are completely disrupted when processed, releasing free starch granules (Watson and Ramstad, 1987). In contrast, there is little release of starch granules during processing for vitreous endosperm because the protein matrix is thicker and stronger. It is generally assumed that corn with a greater proportion of floury endosperm might have greater starch digestibility and be more responsive to processing.

Neutral detergent fiber (“NDF”) from forage is an important component in many ruminant diets. Forage NDF is needed to stimulate chewing and secretion of salivary buffers to neutralize fermentation acids in the rumen. Increasing the concentration of NDF in forage would mean that less NDF would have to be grown or purchased by the farmer. Thus, crops with higher than normal NDF concentrations would have economic value as a fiber source. However, that value would be reduced or eliminated if the higher NDF concentration resulted in lower digestibility and lower available energy concentrations. Beck et al., WO/02096191, recognized the need for optimizing starch degradability by careful selection of corn having specific grain endosperm type, in view of the ruminal rate of starch degradation, moisture content, and conservation methods used, combined with selection of corn for silage production with specific characteristics for NDF content and NDF digestibility.

Selecting a plant based on its genetics for inclusion in a feed formulation results in inconsistent ruminant animal productivity. For example, selection of a corn hybrid based on its grain endosperm type will yield inconsistent ruminant animal productivity over time. Thus, the present invention includes analyzing the starch and fiber digestibility characteristics of grain and a crop plant for use as forage in real time. The present invention also includes preserving the identity of the grain and the crop plant used for forage based on their starch and fiber digestibility characteristics. The present invention further includes using the grain and crop plant used for forage from one or more identity preserved crop plants to create feed formulations that result in optimum productivity of the ruminant animal.

### SUMMARY OF THE INVENTION

A computer-based system for characterizing in real time the nutritional components of one of more ingredients for a ruminant feed ration, including dry matter, NDF; NDFd, lignified NDF ratio, percent starch, IVSD, and particle size for a forage material; and IVSD and particle size for a starch grain material. The system utilizes proprietary NIRS equations based upon prior samplings of a variety of crop species like dual-purpose corn silage, leafy corn silage, brown midrib (“BMR”) corn silage, grass (silage/dry), alfalfa (silage/dry), BMR forage sorghum, normal dent starch grain, floury endosperm starch grain, and vitreous endosperm grain, and applies those equations to current samplings of a corresponding crop to predict in real time the characteristics of such forage or grain material. The real-time characterization system may also utilize the predicted data to calculate a “ration fermentability index” value that takes into account the total NDFd and IVSD characteristics (including RAS and RBS) of the forage and starch ingredients to be used in a feed ration to ensure that the ration will not contribute too much or too little digestibility to the cow. Thus, using the real-time characterization system enables the proper formulation of a ruminant feed ration and the reformulation of that ration where warranted in the case that the NDFd and IVSD characteristics of the feed components change over time.

The associated method of the present invention takes into account environmental factors by measuring the starch and fiber degradation characteristics of a variety of genetically different crop plants and grain from crop plants in real time to determine how the crop plants should be blended into a feed formulation that results in optimum productivity of the ruminant animal. It includes providing a feed formulation resulting in optimum ruminant productivity comprising the steps of determining starch digestibility characteristics of a set of crop plant samples comprising grain of the crop plant, developing a prediction equation based on the starch digestibility characteristics, obtaining a grain sample from a crop plant, determining in real time starch digestibility characteristics by NIRS of the sample by inputting electronically recorded near infrared spectrum data from said NIRS into said equation, storing and/or milling said grain on an identity preserved basis, and determining the amount of the crop plant to incorporate into a feed formulation based on the starch digestibility characteristics.

The associated method of the present invention also includes providing a ruminant diet resulting in optimum ruminant productivity comprising the steps of, determining starch digestibility characteristics of grain from genetically different crop plants, determining NDF digestibility (“NDFd”) characteristics of genetically different crop plants for use as forage, developing prediction equations based on the starch digestibility and NDFd characteristics, obtaining grain samples for use as feed supplements and crop plants for use as forage, determining starch and NDFd characteristics by NIRS of the grain samples and the crop plants by inputting electronically recorded near infrared spectrum data relating to the characteristics into the equations and determining the amounts of the grain and the crop plants to incorporate into a feed formulation based on the starch and NDF digestibility characteristics.

The associated method of the present invention further includes providing a ruminant diet resulting in optimum ruminant productivity comprising the steps of, determining in real time starch digestibility characteristics of grain from a crop plants, determining in real time NDFd characteristics of crop plants for use as forage, preserving the grain and the crop plants for use as forage on an identity preserved basis, and determining the amounts of the grain and the crop plants for use a forage to incorporate into a feed formulation based on the starch and NDFd characteristics.

The real-time characterization method of the present invention enhances the energy utilization of a feed formulation by mixing identity preserved grains together in a formulation to obtain a specified degree of rate and extent of digestion of the feed formulation. It determines the quantity of the grain to be used in a feed formulation based on the compatibility and NDFd of a forage source and rate of starch digestion of the grain source. It further determines the quantity of the grain to be used in a feed formulation based on the level of forage NDF and the degree of rate and extent of starch digestion of grain to be used in the feed formulation.

### DETAILED DESCRIPTION OF THE PREFERRED EMBODIMENT

A computer-based system for characterizing in real time the nutritional components of one of more ingredients for a ruminant feed ration, including dry matter, NDF, NDFd, lignified NDF ratio, percent starch, IVSD, and particle size for a forage material; and IVSD and particle size for a grain material. The system utilizes proprietary NIRS equations based upon prior samplings of a variety of crop species like dual-purpose corn silage, leafy corn silage, brown midrib (“BMR”) corn silage, grass (silage/dry), alfalfa (silage/dry), BMR forage sorghum, normal dent starch grain, floury endosperm starch grain, and vitreous endosperm grain, and applies those equations to current samplings of a corresponding crop to predict in real time the characteristics of such forage or grain material. The real-time characterization system may also utilize the predicted data to calculate a “ration fermentability index” value that takes into account the total NDFd and IVSD characteristics (including RAS and RBS) of the forage and starch ingredients to be used in a feed ration to ensure that the ration will not contribute too much or too little digestibility to the cow. Thus, using the real-time characterization system enables the proper formulation of a ruminant feed ration and the reformulation of that ration where warranted in the case that the NDFd and IVSD characteristics of the feed components change over time.

For purposes of the present invention, “ruminant animal” means any animal having a multiple-compartment stomach for digesting feed ingredients ruminated by the animal, including but not limited to dairy cows, beef cows, sheep, goats, yaks, water buffalo, and camels. Examples of dairy cows particularly include Holstein, Guernsey, Ayshire, Brown Swiss, Jersey, and Milking Shorthorn cows.

In the context of the present invention, “lactation cycle” means the period of time during which a ruminant animal produces milk following the delivery of a new-born animal.

As used within this application, “milk production” means the volume of milk produced by a lactating ruminant animal during a day, week, or other relevant time period.

For purposes of the present invention, “milk peak” means the highest level of milk production achieved by a ruminant animal during the lactation cycle.

For purposes of this invention, “milk stability” means production by the ruminant animal of milk across the lactation cycle in a manner that approaches the ideal lactation volume each day by achieving optimum milk peak and consistent milk persistence curves for the ruminant animal.

As used within this application, “nutritionist” means an individual responsible for specifying the composition of a feeding ration for a ruminant animal. Such nutritionist can be a dairy farmer, employee of a dairy farm company, or consultant hired by such a farmer or company.

For purposes of this invention, “neutral detergent fiber” (“NDF”) means the insoluble residue remaining after boiling a feed sample in neutral detergent. The major components are lignin, cellulose and hemicellulose, but NDF also contains protein, bound nitrogen, minerals, and cuticle. It is negatively related to feed intake and digestibility by ruminants.

As used within this application “NDF digestibility” (“NDFd”) means the amount of NDF that is fermented by rumen microbes at a fixed time point and is used as an indicator of forage quality. Common endpoints for fermentation are: 24, 30, or 48 hours. NDFd is positively associated with feed intake, milk production, and body weight gain in dairy cattle.

For purposes of this invention, “lignified NDF” means the fraction of NDF that is protected from fermentation by its chemical and physical relationship with lignin. It is commonly referred to as indigestible NDF and is often estimated as (lignin×2.4).

As used within this application, “effective fiber,” more commonly referred to as “physically effective fiber” (“peNDF”), means the fraction of NDF that stimulates rumination and forms the digesta mat in the rumen. It is measured as the fraction of particles retained on the 1.18-mm screen when a sample is dry sieved.

For the present invention, “dry matter intake” means the amount of feed (on a moisture-free basis) that an animal consumes in a given period of time, typically 24 hours. Calculated as feed offered-feed refused (all on a moisture-free basis).

For purposes of the present invention, “volatile fatty acids” (“VFA”) are the end product of anaerobic microbial fermentation of feed ingredients in the rumen. The common VFA's are acetate, propionate, butyrate, isobutyrate, valerate, and isovalerate. The VFA's are absorbed by the rumen and used by the animal for energy and lipid synthesis.

The real-time characterization system and associated feeding method and feed composition of the present invention is discussed within this application for a dairy cow. However, it should be understood that this invention can be applied to any other ruminant animal including ruminants that are not used to produce milk like beef steers used for meat production.

A number of different variables impact the effective delivery to and utilization by the dairy cow of nutritional ingredients contained in a feed ration. Called the “GELT Effect” by Applicant, the variables include genetics, environment, location, and traits. The specific genetics of the cow will directly influence its ability to digest and absorb the nutritional ingredients. Likewise, the specific genetics of the forage and grain components of the feed components can directly influence their nutritional content of carbohydrates, protein, and fiber. Therefore, corn genetics used for corn silage production have a significant range of NDF content, NDFd, and percent starch content. Likewise, grain genetics have a wide range of oil, protein, starch composition, and rate and extent of starch digestibility. Thus, the seed genetics determines the potential of each forage and grain quality trait to deliver nutrition to the cow. Failure to use appropriate agronomic inputs (e.g., fertilizers, herbicides, fungicides, pesticides) and levels thereof can also have a deleterious effect upon the quality trail characteristics of the resulting crop grown from the seed.

The environment and weather conditions under which a crop is grown is another key source of variability. The weather is considered an uncontrollable event. No one growing season is the same from one year to the next in terms of temperature and moisture. This directly affects and adds a high degree of variation to forage production, forage quality, and starch digestibility that can create subsequent inconsistencies in a dairy cow's performance. For example temperature and rainfall patterns during a growing season can affect the level of fiber (NDF), the amount, and the effect of lignin on fiber digestibility (NDFd). This subsequently can affect how a forage “feeds,” and can have an increase or decrease effect on dry matter intake (DMI) and energy intake with dairy cows, especially cows that are limited by fill and in early lactation.

Starch digestibility within the kernels of a corn hybrid chopped for silage and corn grain used for energy supplementation can also be variable by a growing season environment. Both the content of starch and the rate and extent of digestion can be altered. Thus, supplement grain added to a diet and the corn grain within corn silage can positively and negatively affect dairy cow productivity. Hence the environment determines the level and range of each forage and grain quality trait.

The temperature and other feeding conditions can also directly influence the cow's willingness or ability to intake dry matter contained in feed rations. Thus, this environmental variation makes it almost impossible to predict and implement a feed programming strategy for a dairy cow in a given production year, or design a cropping or ingredient purchasing program for growing or procuring forage and grain feed ingredients without utilization of some type of real-time adjustment mechanism to account for this uncontrolled variation factor.

Specific harvesting techniques can also have a deleterious influence upon the nutritional content of the feed ingredient. Poor storage techniques (e.g., packing and storage) can also adversely impact the nutritional value of grain, forage or silage. Sampling protocols and laboratory testing errors arising during the analysis of the nutritional profile of a feed ingredient can interfere with construction of an appropriate feed ration. Moreover, the inoculants used to facilitate forage fermentation to produce silage, and preservatives for silage and grain storage can adversely impact the nutritional trails of the silage or grain product. Harvest management techniques therefore determine the net of each forage and grain quality trait. Of course, poor formulation of the feed ration can also affect the proper delivery of nutritional values to the dairy cow.

Therefore, it is important to appreciate that no two forage or grain samples are exactly the same in nutritional content, even if grown from the same seed variety or hybrid, and the nutritional content of different varieties and hybrids will probably vary significantly—all because of this GELT Effect.

A feeding method associated with the real-time characterization system of the present invention is disclosed in Applicant's U.S. Ser. No. 11/494,312 filed on Jul. 27, 2006, and Applicant's co-pending application entitled “Method and Feed for Enhancing Ruminant Animal Nutrition” filed on even date herewith, both of which are incorporated hereby in their entirety.

A feed delivery system associated with the real-time characterization system of the present invention is disclosed in Applicant's U.S. Ser. No. 11/494,312 filed on Jul. 27, 2006, and Applicant's co-pending application entitled “Feed Delivery System for Enhancing Ruminant Animal Nutrition” filed on even date herewith, both of which are incorporated hereby in their entirety.

I. Interactive Effect of a Plant Crop and the Environment

Six corn hybrids were grown in duplicate plots in 3 locations in the 1999 growing season. Locations were East Lansing, Mich.; Lincoln, Nebr.; and University Park, Pa. The six hybrids included several endosperm types: 1 floury, 1 opaque-2, 1 waxy, 1 dent and 2 flint hybrids. Plots were 32 rows wide by 400′ long (30″ rows).

Each field was monitored once per week beginning September 15. Following physiological maturity at black layer (BL), grain dry matter (DM) was determined weekly for all plots. Grain was harvested at 60%, 70% and 80% DM from all plots. To minimize probability of cross-pollination, ten ears were harvested from each of the middle two rows of each plot (rows 16 and 17) for a total of 20 ears. Ears were not harvested from plants within 100′ of the ends of the 400′ long plots and were taken approximately every 20′ along the 200′ remaining. Grain was shelled from the ears by hand. A 500 g sample of grain was taken for determination of DM, vitreousness, and density. The remainder of the grain was rolled and ensiled in duplicate 4″×12″ PVC experimental silos. An additional sample (0.5 kg) was taken as a 0 time sample.

One of each duplicate silo from each plot and maturity was opened at 35-d after harvest and the other was opened at 120-d after harvest. Contents of silos were frozen for subsequent analysis. Samples were ground with dry ice (Wiley mill, 1-mm screen) before analysis. In vitro starch degradation was determined after incubation for 7 h in buffered media with 20% rumen fluid.

All samples were characterized for starch, sugars, ether extract, crude protein content, and protein solubility in sequential buffers. Samples of intact kernels taken at harvest were analyzed for vitreousness and density in ethanol (Philippeau and Michalet-Doreau, 1997). Samples taken after rolling that were not ensiled (n=72) were dried at 55° C., dry sieved and analyzed for particle size. Starch degradability, also referred to herein as digestibility, was determined by vitro starch digestion with rumen microbes and measuring starch disappearance over time. Other methods for measuring starch digestion known in include gas production, in vitro starch disappearance using enzymes, and in situ starch digestion.

Vitreousness of endosperm for the hybrids tested ranged from 4 to 62%. Table 1 shows that starch digestion was affected by the corn hybrid (49.8 to 60.3%, P<0.001). Table 2 shows that starch digestion increased with moisture content (46.0 to 65.8%, P<0.001). Table also shows that starch digestion was affected by ensiling (0 days vs. 35 days and 120 days, 46.3% vs. 59.3%, P=0.001), and time of ensiling (35 days vs. 120 days, 57.4% vs. 61.25%, P<0.001).

Table 3 establishes that starch digestion is dependent on several interactions between hybrid and the environment. A p-value of less than 0.05 is significant for single sources, whereas a p-value of less than 0.1 is significant for interactions between sources. Thus, location, moisture, hybrid, day, all had a significant affect on starch digestibility. The results show that the interactions of Moisture×Day, Moisture×Location, Moisture×Hybrid, and Hybrid×Location were all significant. For example, the affect of the hybrid on starch digestibility changed at different moisture levels. Table 3 also shows that a hybrid's affect on starch digestibility depends on the location where it was grown and, therefore, starch digestibility of a particular hybrid varies across different locations. Tables 4, 5, 6 and 7 show the data for the interaction between hybrids and their growth environments and the affect these interactions have on starch digestibility of the hybrids. For example, Table 4 shows that the affect of Day×Moisture on starch digestibility is disproportionate to either environmental factor alone. Likewise, the interactive effects of Moisture×Location (Table 5), Moisture×Hybrid (Table 6), and Hybrid×Location (Table 7) all show strong interactive affects on starch digestibility.

TABLE 1
Corn hybrid means for in-vitro starch digestibility (IVSD),
averaged over three stages of maturity, 3 post harvest intervals, 2
plots per location and 3 locations.
Effect of Hybrid on IVSD

| Hybrid | IVSD |
|---|---|
| N4342 wx | 49.8 |
| 6409 GQ | 50.9 |
| W1698 | 54.3 |
| N4640Bt | 57.5 |
| NX7219 | 57.5 |
| SL-53 | 60.3 |

SE-1.26

TABLE 2
IVSD means for three moistures and three storage intervals.

| | |
|---|---|
| Effect of | Effect of Day |
| Moisture % on IVSD | on IVSD |

| Moisture % | IVSD | Day | IVSD |
|---|---|---|---|
| 20 | 46.0 | 0 | 46.3 |
| 30 | 53.1 | 35 | 57.4 |
| 40 | 65.8 | 120 | 61.2 |

| | |
|---|---|
| SE = 1.03 | SE = 0.84 |

TABLE 3
Levels of significance for pertinent sources of variation in IVSD.
Treatment Effects on IV Starch Digestibility

| | Degrees of | |
|---|---|---|
| Source | Freedom (DF) | Prob > F |
| Location | 2 | 0.19 |
| Moisture | 2 | <0.0001 |
| Hybrid | 5 | <0.0001 |
| Day | 2 | <0.0001 |
| Moisture × Day | 4 | <0.0001 |
| Moisture × Location | 4 | 0.07 |
| Moisture × Hybrid | 10 | 0.08 |
| Hybrid × Location | 10 | 0.08 |

TABLE 4
IVSD Moisture × Day interaction means for three moistures and
three storage intervals
Moisture × Day

| | Day | | |
|---|---|---|---|
| Moisture % | 0 | 35 | 120 |
| 20 | 43.9 | 46.7 | 47.5 |
| 30 | 44.1 | 55.5 | 59.7 |
| 40 | 50.8 | 70.1 | 76.4 |

TABLE 5
IVSD Moisture × Location interaction means for three moistures
and three locations
Moisture × Location

| | Location | | |
|---|---|---|---|
| Moisture % | #1 | #2 | #3 |
| 20 | 46.1 | 46.8 | 45.2 |
| 30 | 51.5 | 54.6 | 53.3 |
| 40 | 63.8 | 63.2 | 70.3 |

TABLE 6
IVSD Moisture × Hybrid interaction means for three moistures
and six hybrids
Moisture × Hybrid

| | Moisture % | | |
|---|---|---|---|
| Hybrid | 20 | 30 | 40 |
| N4342wx | 41.7 | 44.3 | 63.4 |
| 6409 GQ | 40.9 | 52.8 | 58.9 |
| W1698 | 44.6 | 52.7 | 65.8 |
| N4640Bt | 47.8 | 57.8 | 65.0 |
| NX7219 | 49.9 | 52.5 | 70.2 |
| SL-53 | 51.4 | 58.6 | 71.2 |

TABLE 7
IVSD Hybrid × Location interaction means for six hybrids and
three locations. The number in parentheses is the rank of the
hybrid within location.
Hybrid × Location

| | Location | | |
|---|---|---|---|
| Hybrid | #1 | #2 | #3 |
| N4342wx | 51.1 (4) | 51.4 (5) | 46.9 (6) |
| 6409 GQ | 49.7 (6) | 50.1 (6) | 52.8 (5) |
| W1698 | 50.0 (5) | 54.2 (4) | 58.7 (2) |
| N4640Bt | 56.2 (3) | 61.2 (2) | 53.2 (4) |
| NX7219 | 56.4 (2) | 58.9 (3) | 57.3 (3) |
| SL-53 | 59.4 (1) | 61.5 (1) | 60.2 (1) |

II. Measurement of Starch and Fiber Degradability Characteristics

The current inventory of forage and grain ingredients on farm, as well as any new forage and grain crops that may be planted by the dairy farm need to be characterized in real time. A representative sample of each field is obtained and scanned using NIRS at the wavelengths required by a corresponding prediction equation previously developed. Fiber digestion characteristics of the plants in each field are predicted using this equation. Moreover, the starch digestibility characteristics of the starch and forage sources are also predicted using this set of equations. The starch characterisitics are then used to determine the ruminal available starch (RAS) and ruminal by-pass starch (RBS) of the multiple sources in the feed ration.

The “Ration Fermentability Index” (“RFI”) tool constitutes a series of interrelated calculations that evaluate the nutritional effectiveness of the feed ration, and its ability to safefly deliver nutritional value to the dairy cow for the pertinent production stage. First, it takes into account the total digestibility of the feed ration, compiling the pounds of digestible fiber contributed by the forage source and the pounds of digestible starch contributed by the grain and forage sources. A range should be specified for this total digestibility within the Nutritional Template 32 for each stage of production of the cows. By checking the NDFd and IVSD values of the various forage and grain starch ingredients used within the feed ration using the real-time characterization tool 98 on a periodic basis, and plugging these values into the total digestibility equation, the nutritionist can determine whether the GELT Effect has caused one or more of the feed ingredients to provide too much or too little fiber and starch digestibility to the cow that is fed the feed ration.

Next, the NDFd and IVSD values should be measured for the individual feed components. This data will tell the nutritionist which specific ingredients are contributing the fiber and starch digestibility to the feed ration. For different stages of production, the cow may need different levels of NDFd and IVSD.

Next, the relative ruminal starch (“RAS”) and ruminal bypass starch (“RBS”) values should be calculated to see whether the RAS/RBS ratio is within the range specified within the Nutritional Template. By controlling the RAS/RBS ratio, maximum healthy milk production may be obtained.

Finally, by comparing the total ration digestibility, individual component digestibilities, and dry matter, NDF, NDFd, IVSD, and RAS/RBS ratio values for the total diet against the corresponding values specified within the Nutritional Template, the nutritionist can quickly and accurately determine in real time through this RFI tool 220 whether the feed ration ingredients need to be adjusted to bring the diet into conformity with the specifications during the production stage. Not only can this lead to enhanced milk production and stability, but also it can save the cows from serious health issues suffered from feed rations that are too “hot” because individual feed components exhibited unexpectedly high digestibility.

This NIRS analysis is done in a laboratory or in the field using a portable NIRS instrument. It is desirable that the methods to measure these traits are relatively quick, e.g., in real time. Real time refers to obtaining the starch and fiber digestibility results within 48 hours from when the samples are obtained and tested, and more preferably within 24 hours from when the samples are obtained and tested.

The NIRS method includes obtaining a set of crop plant samples with known characteristic such as starch and fiber degradability. These characteristics are measured according to the IVSD and NDFd measurement methods described below. Other starch and NDFd measurement methods known in the art can be used as well. These crop plant samples are scanned in the near infrared spectrum. Reflectance in the near-infrared spectrum is then recorded. A prediction equation for each trait is developed by regressing the known measured characteristics on reflectance across wavelengths for each set of samples.

For each trait, the prediction equation is validated by predicting the characteristic of interest for an independent set of samples. According to the present invention, the measured characteristics of interest in grain include without limitation: % IVSD in the grain, corn silage, HMC or dry corn, and particle size. These values reflect the rate and extent of ruminal starch digestibility at a specified digestion period, usually 7 hours. IVSD should be measured at different particle sizes, such as 6 mm, 4 mm, 2 mm, 2 UD, and 1 UD. For the forage sources, characteristics of interest include without limitation dry matter content, NDF, fiber digestibility (NDFd), lignin content, in vitro whole plant digestibility (IVTD), corn silage starch digestibility (IVSD-CS), corn silage particle size at different lengths of chop (peNDF) and conservation processing methods. Finally, separate equations should be developed for different crop species to be used with the feed rations, including but not limited to dual-purpose corn, leafy corn, BMR corn, grass (silage/dry), alfalfa (silage/dry), and BMR forage sorghum, normal dent corn starch grain, mutt corn starch grain, floury endosperm starch grain, and vitreous endosperm starch grain. Furthermore, prediction equations can predict the fiber or starch digestibility characteristics of the forage or starch component for different particle sizes. Of significant value is the fact that an “as-is” wet crop sample can be evaluated in real time without the need to dry and grind it as conventional laboratory NIRS instruments require.

Near-infrared reflectance spectroscopy (NIRS) is a nondestructive, instrumental method for rapid, accurate, and precise determination of the chemical composition of forages and feedstuffs. NIRS is an accepted technology for feed and forage analysis, and industrial uses. NIRS has several distinct advantages: the speed of analysis, non-destructive analysis of the sample, simplicity of sample preparation, and several analyses can be completed with one sample. Since NIRS analysis is relatively simple to perform, operator-induced errors are reduced (Shenk and Westerhaus, 1994).

To measure starch degradability in vitro, a set of crop plant samples comprising a number of genetically different crop plants are analyzed for starch concentration before and after incubation in media inoculated with rumen fluid containing ruminal microbes for various lengths of times. Starch degradability is calculated as the amount of starch that disappeared as a percent of the total starch in the sample for each time point of interest. Starch concentration can be determined by analysis of glucose concentration before and after hydrolysis using commercially available analysis kits. Glucose concentration may be determined enzymatically using glucose oxidase method or by high performance liquid chromatography. For general methods of measuring feed digestibility in vitro see Goering and Van Soest (1970). An alternative method is to incubate feed samples in porous bags in the rumen of cattle or sheep. (Philippeau and Michalet-Doreau, 1997).

To measure fiber digestibility in vitro, dried plant tissues were ground with a Wiley® mill to pass a 1 mm screen. In vitro true digestibility (IVTD) and in vitro neutral detergent fiber digestibility was determined using 0.5 g samples using a modification of the method of Goering and Van Soest (1970) with an incubation time representing the rumen residence time of the animal of interest such as 30 h. Undigested IVTD residue was subjected to the neutral detergent fiber (NDF) procedure (Goering and Van Soest, 1970). A modification of the NDF procedure was the treatment of all samples with 0.1 ml of alpha-amylase during refluxing and again during sample filtration, as described by Mertens (1991). Alpha-amylase was assayed for activity prior to use, according to Mertens (1991). NDF digestibility (dNDF) for each sample was computed by the equation: 100*[(NDF−(100−IVTD))/NDF].

Accuracy of the laboratory values for defining the forage quality parameters of the forage and the starch digestibility profile of the grains is paramount to value creation from the invention. To maximize the synergy of the forage and grain specs, the accuracy of the forage template to capture the forage synergy of the forage sources, and to properly develop the Feeding Template requires accurate characterization. It is therefore important to use only analytical laboratories that are certified by the National Forage Testing Association (NFTA) to maintain the accuracy and consistency of the characterization process.

The invention requires an approved certified lab to characterize both forage and grains to establish a historic baseline for each characterized trait. This baseline can be used to determine the hybrid genetic effect and the environmental effect within a given growing season on the forage quality traits and the potential feeding value of both forages and grains used in the Nutritional Template. Accurate adjustments can then be made to the Nutritional Template to maintain the accuracy of the resulting Feeding Template for each stage of dairy cow production.

The same real-time characterization process is used in the genetic development of superior forage and grain genetics necessary for the feed ingredients. Real-time characterization measures the direction, progress and level of trait enhancement of the breeding process. It also is used as a database development tool for screening and identifying the top performing genetics for invention application.

According to the present invention, databases are developed relating the NIR spectrum to the starch and fiber degradability characteristics of a number of genetically different crop plants. The NIR spectrums of a given crop plant such as corn, soybean, or alfalfa are used to assess the crop plant's starch and fiber degradability characteristics. The NIRS method may be applied to various feed crops and the traits of those crops. NIRS requires a calibration to reference methods (Shenk and Westerhaus, 1994). Each constituent requires a separate calibration, and in general, the calibration is valid for similar types of samples.

The NIRS method of analysis is based on the relationship that exists between infrared absorption characteristics and the major chemical components of a sample (Shenk and Westerhaus, 1994). The near infrared absorption characteristics can be used to differentiate the chemical components. Each of the significant organic plant components has absorption characteristics (due to vibrations originating from the stretching and bending of hydrogen bonds associated with carbon, oxygen and nitrogen) in the near infrared region that are specific to the component of interest. The absorption characteristics are the primary determinants of diffuse reflectance, which provides the means of assessing composition. The diffuse reflectance of a sample is a sum of the absorption properties combined with the radiation-scattering properties of the sample. As a consequence the near infrared diffuse reflectance signal contains information about sample composition. Appropriate mathematical treatment of the reflectance data will result in extraction of compositional information. (Osboure et al., 1986). The most rudimentary way to illustrate this would be to measure the reflectance at two wavelengths, with one wavelength chosen to be at a maximum absorption point and the other at the minimum absorption point, for the compositional factor to be analyzed. The ratio of the two reflectance values, based on determination of two samples, can be associated, by correlation, to the concentration of the specific compositional factor in those samples. By use of the correlation relationship, an equation can be developed that will predict the concentration of the compositional factors from their reflectance measurements (Osboure et al., 1986).

Spectra can be collected from the sample in its natural form, or as is often the case with plants or plant parts, they are ground, typically to pass through a 1-mm screen. NIR reflectance measurements are generally transformed by the logarithm of the reverse reflectance (log (1/R)) (Hruschka, 1987), other mathematical transformations known in the art may be used as well. Transformed reflectance data are further mathematically treated by employment of first- or second-derivatives, derivatives of higher order are not commonly used (Shenk and Westerhaus, 1994).

The calibration techniques employed are multiple linear regression (MLR) methods relating the NIR absorbance values (x variables) at selected wavelengths to reference values (y values), two commonly used methods are step-up and stepwise regression (Shenk and Westerhaus, 1994). Other calibration methods are principal-component regression (PCR) (Cowe and McNicol, 1985), partial least-squares regression (PLS) (Martens and Naes, 1989), and artificial neural networks (ANN) (Naes et al., 1993).

The methods of calibration equation differ depending on the regression method used. The procedure when using MLR is to randomly select samples from the calibration population, exclude them from the calibration process and then use them as a validation set to assess the calibration equation (Windham et al., 1989). The method of equation validation used for PCR or PLS regression is cross-validation, which involves splitting the calibration set into several groups and conducting calibration incrementally on every group until each sample has been used for both calibration and validation (Jackson, 1991; Martens and Naes, 1989; Shenk and Westerhaus, 1994).

In this instance, NIRS involves the collection of spectra for a set of samples with known characteristics. The spectra is collected from grain kernels, or other plant parts, and mathematically transformed. A calibration equation is calculated using the PLS method, other regression methods known in the art may be used as well. Criteria used to select calibration equations are low standard errors of calibration and cross validation and high coefficients of multiple determinations.

This tool can also be used to measure quality trains for crop plants other than NFDd and IVSD, such as oil content, crude protein, and NDF.

The real-time characterization system of the present invention is a computer-based tool. It comprises a general programmable computer having a central processing unit (“CPU”) controlling a memory unit, a storage unit, an input/output (“I/O”) control unit, and at least one monitor. The computer operatively connects to a database, containing, e.g., dry matter, NDF, NDFd, IVSD, particle size, etc. data for a variety of hybrids and varieties for a variety of crop plants. It may also include clock circuitry, a data interface, a network controller, and an internal bus. One skilled in the art will recognize that other peripheral components such as printers, drives, keyboards, mousse and the like can also be used in conjunction with the programmable the computer. Additionally, one skilled in the art will recognize that the programmable computer can utilize known hardware, software, and the like configurations of varying computer components to optimize the storage and manipulation of the data and other information contained within the real-time characterization tool.

An NIRS reflectance apparatus is used to measure the reflected wavelength of crop samples, and the resulting NIRS data is stored in the database. A software program may be designed to be an expression of an organized set of instructions in a coded language. These instructions are programmed to interact with proprietary prediction equations stored in the memory. When a crop sample in subjected to NIRS analysis in real time, the resulting NIRS data is used by the prediction equations to predict the actual true value of the associated characteristics of the real-time crop sample. As mentioned above, the prediction equations can further predict the fiber or starch digestibility of the forage or grain material at different particle sizes, which can be of great assistance in formulating feed rations.

The computer system on which the system resides may be a standard PC, laptop, mainframe, handheld wireless device, or any automated data processing equipment capable of running software for monitoring the progress of the transplantable material. The CPU controls the computer system and is capable of running the system stored in memory. The memory may include, for example, internal memory such RAM and/or ROM, external memory such as CD-ROMs, DVDs, flash drives, or any currently existing or future data storage means. The clock circuit may include any type of circuitry capable of generating information indicating the present time and/or date. The clock circuitry may also be capable of being programmed to count down a predetermined or set amount of time. This may be particularly important if a particular type of tissue needs to be refrigerated or implanted in a predetermined amount of time.

The data interface allows for communication between one or more networks which may be a LAN (local area network), WAN (wide area network), or any type of network that links each party handling the tissue. Different computer systems such as, for example, a laptop and a wireless device typically use different protocols (i.e., different languages). To allow the disparate devices to communicate, the data interface may include or interact with a data conversion program or device to exchange the data. The data interface may also allow disparate devices to communicate through a Public Switched Telephone Network (PSTN), the Internet, and private or semi-private networks.

Outputs produced by such real-time characterization system include the predicted characteristic values for the real-time sample. However, the system may also be programmed to run the various computations associated with the Ration Fermentability Index (RFI) discussed above, and warn the user if a feed ration formulated in accordance with the feed ingredients analyzed by the real-time characterization system will lie outside of the Nutritional Template specifications, and which ingredient caused any problems. This can assist a nutritionist with reformulating feed rations for ruminant animals. The system can also produce and print a series of reports documenting this information.

III. Real-Time Feed Formulation Method

Crops about to be harvested are analyzed for starch and fiber degradation characteristics before harvest to provide information needed for harvesting decisions. A representative sample of each field is obtained and scanned using an NIR spectrophotometer at the wavelengths required by the prediction equation previously developed. Starch and/or fiber digestion characteristics of the plants in each field are predicted using this equation. Information provided is used to make harvest decisions such as the moisture concentration at harvest and particle size to grind for high moisture grain and the conservation method (high moisture grain or dry grain). This gives additional control over the resulting feed consumed by cattle and sheep, which helps optimize energy intake and nutrient utilization. The NIRS analysis is done in a laboratory or in the field using a portable NIRS instrument.

Stored feed samples are screened for starch and fiber digestibility characteristics to provide information to formulate diets for optimal energy intake and nutrient utilization. Feeds with highly degradable starch are limited in diets to prevent ruminal acidosis, lower fiber digestibility and efficiency of microbial protein production, and decrease energy intake. Feed with low starch degradability is limited to optimize microbial protein production, nutrient utilization and energy intake.

The present invention also includes using traditional real-time screening techniques, such as wet chemistry, to determine the starch and/or fiber digestibility characteristics of a particular crop in the field or a crop that is stored on an identity preserved basis. The invention, therefore includes, analyzing the starch and/or fiber digestibility of an identity preserved crop in real-time, using techniques described herein or other techniques known in the art, and using that information to prepare feed formulations that optimize ruminant productivity.

The present invention also includes growing a crop at a particular location and determining the starch degradability characteristics of the crop plant used as grain or NDF digestibility if used as a forage in real time, before or after harvest, by NIRS. The crop plant or plant parts are stored on an identity preserved basis. Based on specific diet requirements, conservation methods such as high-moisture fermentation or harvesting field dried, and processing including either rolling or grinding, are used to alter measured starch degradability. Once a specific starch degradability target/requirement for a ruminant herd is determined, a blending process of mixing fast and slow starch degradation properties that have been accurately measured according to the present invention are incorporated into a feed formulation for optimum ruminant productivity.

It is understood that the present invention is applicable to corn, alfalfa, and other forage crops, and can also be used to characterize forage sources in real time. Thus, the term “crop plant” or “crop” is meant to include any plant that is used as silage, grain or other plant based feed ingredient for ruminant animals.

The plant characteristics, energy (digestibility), protein and fiber content of both corn grain and corn forage is affected by the interaction of genetics by environment (G×E). Thus, according to the present invention, real-time characterization of each source of starch (grain) and NDF (fiber) is necessary to accurately formulate diets for ruminates. Once an animal production target is determined, a total mixed ration (TMR) is designed by combining energy, protein, fiber, vitamins and mineral ingredients into a mixer wagon based on predetermined metabolizable energy (ME) targets, crude protein and meeting adequate and sufficient fiber requirements.

Meeting the total ration NDF target and the level of NDF as a percentage of the total forage in the diet determines the forage component of the base diet. An adjusted ME value for the forage sources is determined to account for the energy contribution (NDF digestibility) from the forage NDF.

The production requirement of the diet and the forage/fiber composition of the diet will determine the optimal amount and source of supplemental starch, with either a fast, slow or mid-point of starch degradability needed to make the most feed efficient, productive and healthy diet formulation. The forage characteristics of the diet also determines the optimum moisture content of the starch, either dry grain (15.5%) or high moisture grain, such as high moisture corn (HMC) at 28-32% by weight, and which conservation and processing methods are advantageous to the production and health impact of the diet.

It is understood, therefore, that the present invention is a system that optimizes a ruminant feed formulation by analysis of identity preserved feed components on a real-time basis. It is further understood that the present invention includes using various methods of measuring, in real time, crop plant characteristics.

The above specification, drawings, and data provide a complete description of the feeding method and resulting feed compositions of the present invention. Since many embodiments of the invention can be made without departing from the spirit and scope of the invention, the invention resides in the claims hereinafter appended.

### LITERATURE CITED

Dado, R. G., and R. W. Briggs. 1996. Ruminal starch digestibility of grain from high-lysine corn hybrids harvested after black layer. J. Dairy Sci. 79(Suppl. 1):213.
Philippeau, C. and B. Michalet-Doreau. 1996. Influence of genotype of corn on rate of ruminal starch degradation. J. Dairy Sci. 79(Suppl. 1):138.
Philippeau, C. and B. Michalet-Doreau. 1997. Influence of genotype and stage of maturity of maize on rate of ruminal starch degradation. Animal Feed Sci. Tech. 68:25-35.
Philippeau, C. and B. Michalet-Doreau. 1999. Influence of genotype and ensiling of corn grain on in situ degradation of starch in the rumen. J. Dairy Sci. 81:2178-2184.
Stock, R. A., M. H. Sindt, R. Cleale IV, and R. A. Britton. 1991. High-moisture corn utilization in finishing cattle. J. Anim. Sci. 69:1645.
Watson, S. A., and P. E. Ramstad. Ed. 1987. Corn Chemistry and Technology. Am. Soc. Cereal Chem., St. Paul, Minn.
Cowe, I. A. and J. W. McNicol. 1985. The use of principal components in the analysis of near infrared spectra. Applied Spectroscopy 39:257-266.
Jackson, J. E. 1991. A user's guide to principal components. John Wiley and Sons. New York, N.Y.
Hruska, W. R. 1987. Data analysis: Wavelength selection methods. p.35-56. In P. Williams and K. Norris (ed.) Near-infrared technology in the agricultural and food industries. American Association of Cereal Chemists. St. Paul, Minn.
Martens, H., and T. Naes. 1989. Multivariate calibration. John Wiley and Sons, New York, N.Y.
Naes, T., K. Kvaal, T. Isaksson, and C. Miller. 1993. Artificial neural networks in multivariate calibration. Journal of Near Infrared Spectroscopy 1:1-12.
Osbourne, B. G., T. Fearn, and P. H. Hindle. 1986. Practical NIR spectroscopy with applications in food and beverage analysis. Longman Scientific and Technical. Essex, England.
Shenk, J. S. and M. O. Westerhaus. 1994. The application of near infrared reflectance spectroscopy (NIRS) to forage analysis. p. 406-499. In G. C. Fahey (ed.) Forage quality, evaluation, and utilization. National conference on Forage quality, evaluation, and utilization, University of Nebraska, Lincoln, Nebr., 13-15 Apr. 1994. ASA, CSCA, SSSA, Madison, Wis.
Windham, W. R., D. R. Mertens, F. E. Barton II. 1989. Supplement 1. Protocol for NIRS calibration: sample selection and equation development and validation. p. 96-103 In: Marten, G. C., J. S. Shenk, and F. E. Barton II (eds.) Near infrared reflectance spectroscopy (NIRS): Analysis of forage quality. USDA Agricultural handbook No. 643 Washington, D.C.
Goering, H. K., and P. J. Van Soest. 1970. Forage fiber analysis: apparatus, reagents, procedures, and some applications. USDA-ARS Handbook 379. U.S. Govt. Print. Office, Washington, DC.
Martens, G. C., and R. F. Barnes. 1980. Prediction of energy digestibilities of forages with in vitro rumen fermentation and fungal enzyme systems. p. 61-71. In W. J. Pigden et al. (ed.) Proc. Int. Workshop on standardization of analytical methodology for feeds. IDRC-134e, Ottawa, Canada. 12-14 Mar. 1979. Unipub. New York, N.Y.
Mertens, D. R. 1991. Neutral detergent fiber. p. A12 A16. In Proc. National Forage Testing Association forage analysis workshop. Milwaukee, Wis. 7-8 May 1991.

What is claimed is:

1. A system for characterizing in real time crop plants to be used in a feed ration to optimize productivity of a ruminant animal that consumes such feed ration, such system comprising:
(a) determination of starch digestibility characteristics of a set of crop plant samples comprising grain of said crop plant samples;
(b) development of a prediction equation based on said starch digestibility characteristics;
(c) obtaining a grain sample from a crop plant;
(d) determination in real time of the starch digestibility characteristics by NIRS of said sample by inputting electronically recorded near infrared spectrum data from said NIRS into the equation;
(e) storing and/or milling said grain on an identity preserved basis; and
(f) determination of the amount of such crop plant to incorporate into a feed ration based upon the starch digestibility characteristics determined in step (d).

2. The real-time characterization system according to claim 1, wherein the crop plant is brown midrib corn.

3. The real-time characterization system according to claim 1, wherein the crop plant is dual-purpose corn.

4. The real-time characterization system according to claim 1, wherein the crop plant is leafy corn.

5. The real-time characterization system according to claim 1, wherein the crop plant is alfalfa.

6. The real-time characterization system according to claim 1, wherein the crop plant is grass.

7. The real-time characterization system according to claim 1, wherein the crop plant is sorghum.

8. The real-time characterization system according to claim 1 further comprising:
prediction of starch digestibility characteristics of the crop plant samples comprising grain of said crop plant samples at various particle sizes, based upon the prediction equations.

9. A system for characterizing in real time crop plants to be used in a feed ration to optimize productivity of a ruminant animal that consumes such feed ration, such system comprising:
(a) determination of starch digestibility characteristics of grain from genetically different crop plants;
(b) determination of dNDF characteristics of genetically different crop plants for use as forage;
(c) development of prediction equations based on said starch digestibility and dNDF characteristics;
(d) obtaining grain samples for use as feed supplements and crop plants for use as forage;
(e) determination of starch and NDF digestibility characteristics by NIRS of said grain samples and said crop plants by inputting electronically recorded near infrared spectrum data relating to said characteristics into said equations; and
(f) determination the amounts of said grain and said crop plants to incorporate into a feed formulation based on the starch and NDF digestibility characteristics determined in step (e).

10. The real-time characterization system according to claim 9, wherein the crop plant is brown midrib corn.

11. The real-time characterization system according to claim 9, wherein the crop plant is dual-purpose corn.

12. The real-time characterization system according to claim 9, wherein the crop plant is leafy corn.

13. The real-time characterization system according to claim 9, wherein the crop plant is alfalfa.

14. The real-time characterization system according to claim 9, wherein the crop plant is grass.

15. The real-time characterization system according to claim 9, wherein the crop plant is sorghum.

16. The real-time characterization system according to claim 9 further comprising prediction of starch digestibility characteristics of the crop plant samples comprising grain of said crop plant samples at various particle sizes, based upon the prediction equations.

17. The real-time characterization system according to claim 9 further comprising prediction of forage digestibility characteristics of the crop plant samples comprising forage of said crop plant samples at various particle sizes, based upon the prediction equations.

18. The real-time characterization system according to claim 1, wherein such system comprises a computer-based tool incorporating such prediction equations.

19. The real-time characterization system according to claim 19, wherein such system is portable.

20. The real-time characterization system according to claim 1 further comprising calculation of one or more ration fermentability index values for the resulting feed ration based upon the characterized values of the crop plants to determine whether the feed ration should be reformulated.
